(19) United States
(12) Patent Application Publication
(10) Pub. No.: US 2025/0105607 A1
(43) Pub. Date: Mar. 27, 2025

(54) ELECTRICAL JUNCTION BOX

(71) Applicant: YAZAKI CORPORATION, Tokyo (JP)

(72) Inventors: Hirotaka Kiyota, Makinohara-shi (JP); Takeshi Onoda, Makinohara-shi (JP)

(21) Appl. No.: 18/976,341

(22) Filed: Dec. 11, 2024

Related U.S. Application Data
(63) Continuation of application No. PCT/JP2023/037621, filed on Oct. 18, 2023.

(30) Foreign Application Priority Data
Nov. 24, 2022 (JP) 2022-187143

(51) Int. Cl. H02G 3/16; B60R 16/03

(52) U.S. Cl. CPC H02G 3/16; B60R 16/03

(57) ABSTRACT

What is included is a circuit branch component disposed outside a cylindrical portion and outside the frame and having a conductive circuit branch member, in which a conductive power-side electrical connection structure is provided outside the frame, the conductive power-side electrical connection structure being capable of physically and electrically connecting a power supply-side terminal fitting at an end of a power supply-side electric wire, a second electrical connection portion of an internal conductive member, and a power supply connection portion of the circuit branch member, and a power supply-side electrical connection structure capable of causing a clip at an end of a booster cable to be engaged is provided, and an attaching/detaching work space for attaching and detaching the clip to and from the power supply-side electrical connection structure is provided between the frame and the power supply-side electrical connection structure.

### CROSS-REFERENCE TO RELATED APPLICATION(S)

This application is a continuation application of International Application PCT/JP2023/037621, filed on Oct. 18, 2023 which claims the benefit of priority from Japanese Patent Application No. 2022-187143 filed n Nov. 24, 2022 and designating the U.S., the entire contents of which are incorporated herein by reference.

### BACKGROUND OF THE INVENTION

### 1. Field of the Invention

The present invention relates to an electrical junction box.

### 2. Description of the Related Art

In the electrical junction box, an electronic component such as a relay interposed between an external power supply such as a secondary battery and a load is housed in a housing. In the electrical junction box, an electric wire electrically connected to the electronic component is routed in a housing, and the electric wire is pulled out of the housing to be electrically connected to a power supply or a load. For example, this conventional electrical junction box is disclosed in Japanese Patent Application Laid-open No. 2014-93888 below.

Meanwhile, in a vehicle such as an automobile, a power feeding structure for feeding power from a rescue vehicle or the like to a secondary battery having a reduced voltage is provided. As this power feeding structure, for example, a rescue terminal electrically connected to a secondary battery in a housing of an electrical junction box is known. The rescue terminal is accommodated in the housing together with the power supply-side terminal fitting electrically connected to the secondary battery, and is assembled to the power supply-side terminal fitting. In the conventional electrical junction box, arrangement of other components in the housing is restricted by the power feeding structure housed in the housing.

### SUMMARY OF THE INVENTION

Therefore, an object of the present invention is to provide an electrical junction box capable of giving a degree of freedom to a component layout in a housing.

An electrical junction box according to one aspect of the present invention includes that an electronic component; an internal conductive member that electrically connects the electronic component to an external power supply; a frame including a cylindrical wall provided with an opening at least at one end, and having a cylindrical portion that houses and holds the electronic component and the internal conductive member in the inside of the cylindrical portion; a cover member that is fitted to an opening peripheral edge portion of a peripheral edge of the opening of the cylindrical portion and closes the opening of the cylindrical portion; and a circuit branch component that is disposed outside the frame and outside the cylindrical portion and is interposed between the external power supply and an external load, wherein the internal conductive member includes a first electrical connection portion and a second electrical connection portion that are physically and electrically connected to the electronic component in the inside of the cylindrical portion, the circuit branch component is disposed outside the frame and outside the cylindrical portion and includes a power supply connection portion that physically and electrically connects a power supply-side terminal fitting at an end of a power supply-side electric wire electrically connected to the external power supply and the second electrical connection portion of the internal conductive member, and a load connection portion that causes a load-side electric wire electrically connected to the external load to be electrically connected, a conductive power supply-side electrical connection structure that physically and electrically connects the power supply-side terminal fitting at an end of the power supply-side electric wire, the second electrical connection portion of the internal conductive member, and the power supply connection portion of the circuit branch component, and is capable of causing a clip at an end of the booster cable to be engaged is provided outside the cylindrical portion and outside the frame, and an attaching/detaching work space for attaching and detaching the clip to and from the power supply-side electrical connection structure is provided between the frame and the power supply-side electrical connection structure.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an electrical junction box according to an embodiment;

FIG. 2 is a perspective view illustrating the electrical junction box (without the first cover member) according to the embodiment together with a clip;

FIG. 3 is a plan view of the electrical junction box (without a first cover member) according to the embodiment as viewed from one opening side of a frame;

FIG. 4 is a plan view of the electrical junction box (without the first cover member) according to the embodiment as viewed from the lateral side of the frame;

FIG. 5 is an exploded perspective view illustrating the electrical junction box (without the first cover member and a second cover member) according to the embodiment;

FIG. 6 is a cross-sectional view taken along line X-X of FIG. 4;

FIG. 7 is an exploded perspective view illustrating a block, and an internal conductive member and a male screw member accommodated in the block;

FIG. 8 is an exploded perspective view of a frame and the second cover member in the electrical junction box (without the first cover member) according to the embodiment;

FIG. 9 is an exploded perspective view for explaining a load-side electrical connection structure;

FIG. 10 is a perspective view illustrating a circuit protection member;

FIG. 11 is a perspective view illustrating the frame;

FIG. 12 is a perspective view illustrating a first cover member;

FIG. 13 is a perspective view illustrating a first divided cover;

FIG. 14 is an enlarged view of a portion A in FIG. 2, and illustrates an example of an attachment mode of a clip; and

FIG. 15 is an explanatory view illustrating a modification of the attachment mode of the clip.

### DETAILED DESCRIPTION OF THE PREFERRED EMBODIMENTS

Hereinafter, an embodiment of an electrical junction box according to the present invention will be described in detail with reference to the drawings. Note that the present invention is not limited by the embodiment.

### Embodiment

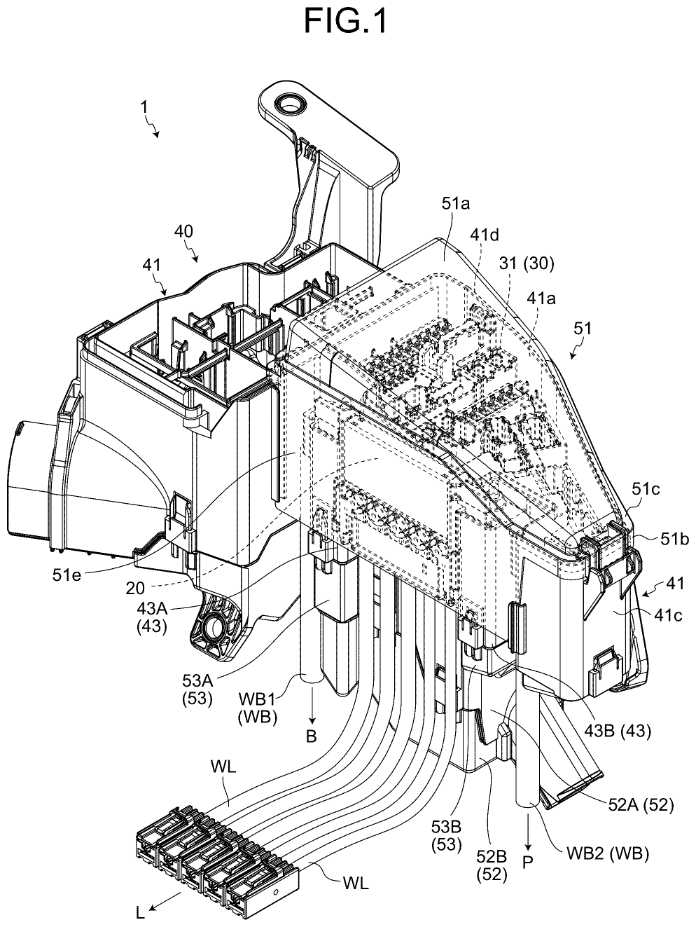

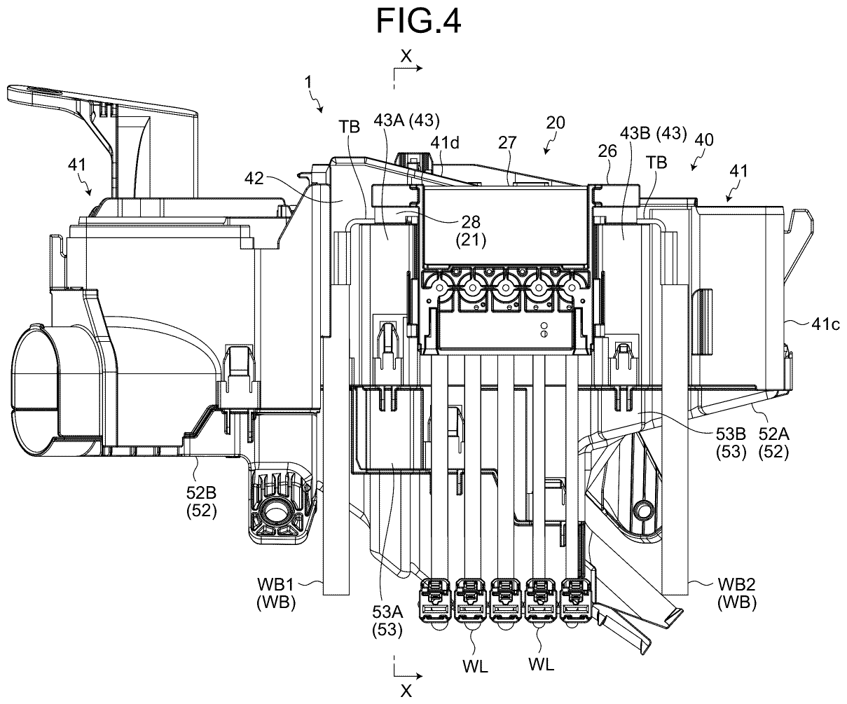

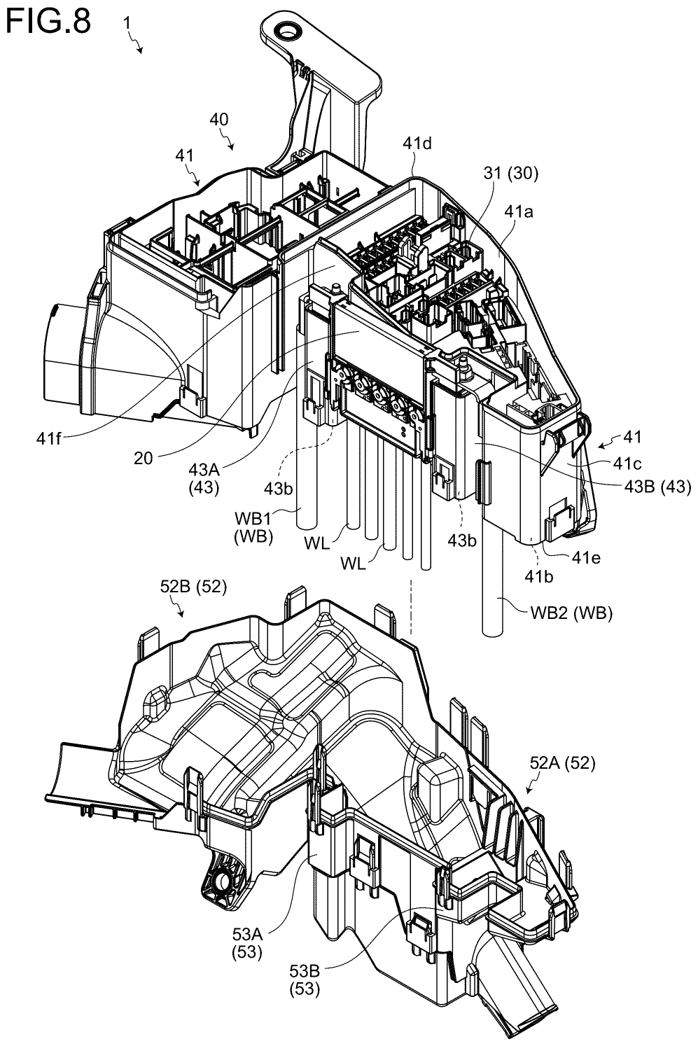

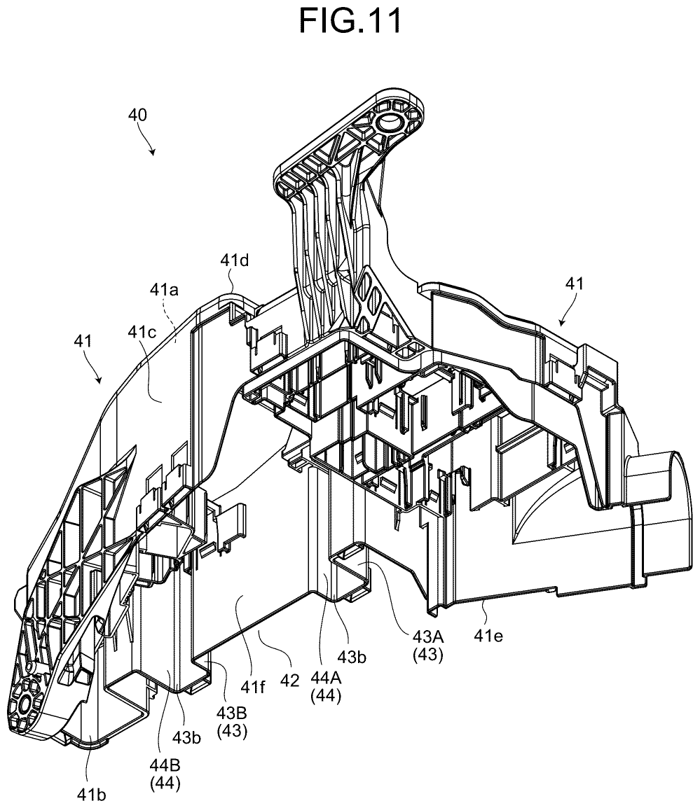

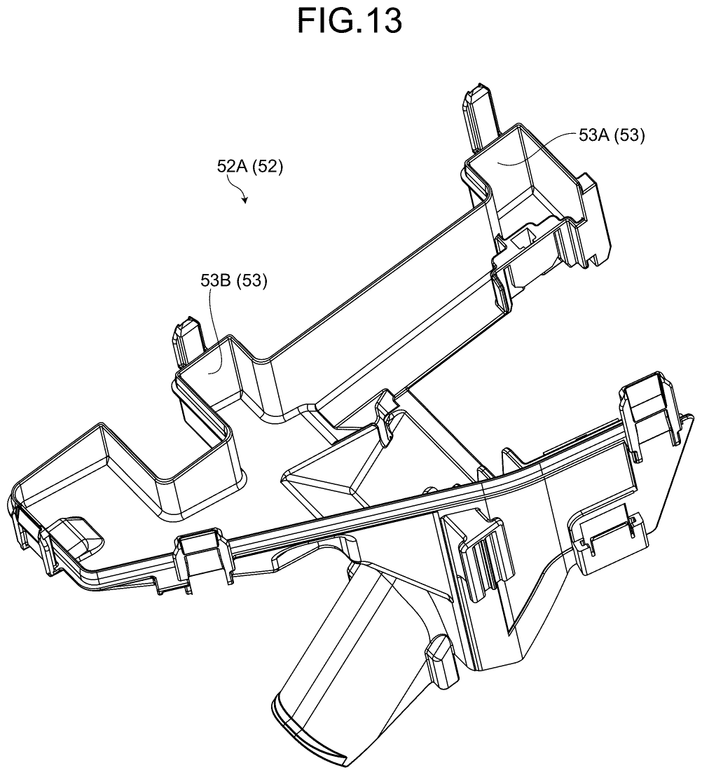

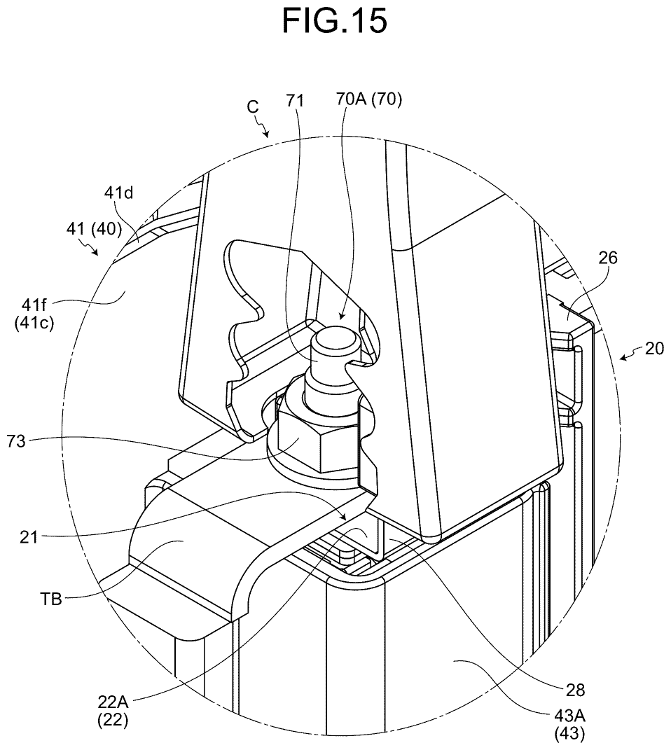

An embodiment of the electrical junction box according to the present invention will be described with reference to FIGS. 1 to 15.

Reference numeral 1 in FIGS. 1 to 6 denotes an electrical junction box of the present embodiment. This electrical junction box 1 is mounted on a vehicle such as an automobile, and is interposed between an external power supply B such as a secondary battery in the vehicle and an external load L such as a power distribution target (for example, auxiliary equipment to be supplied with power, and the like), thereby supplying power of the external power supply B to the external load L (FIG. 1).

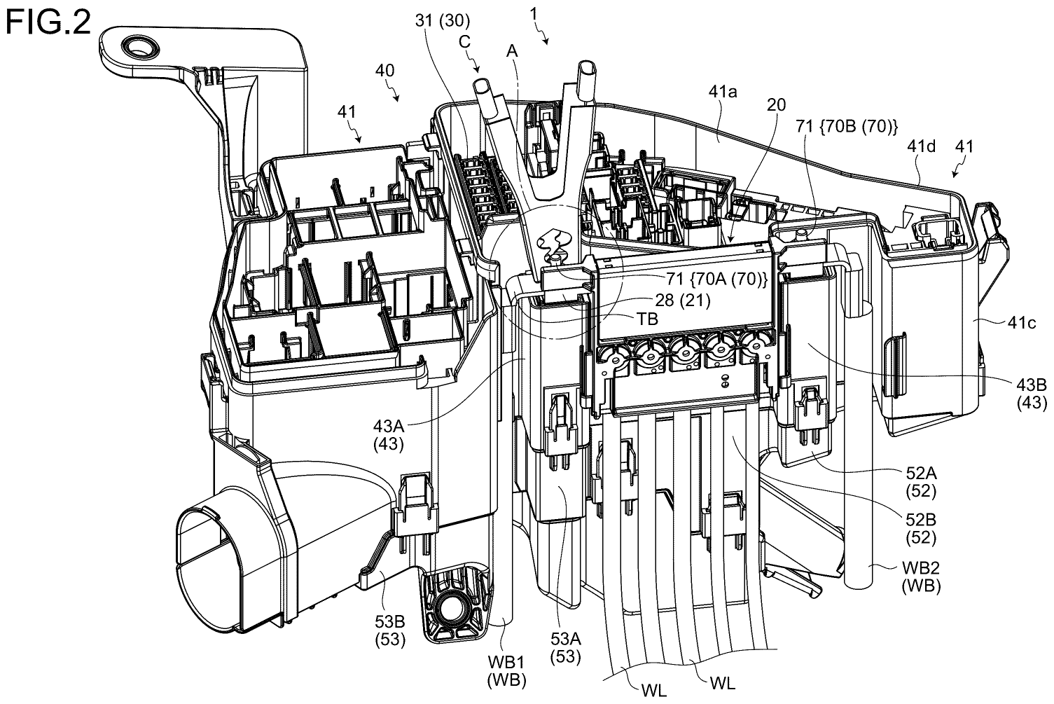

The electrical junction box 1 includes an electronic component 10 such as a relay or a fuse (FIG. 2), and the electronic component 10 is interposed between the external power supply B and the external load L. Further, the electrical junction box 1 includes a circuit branch component 20 interposed between the external power supply B and the external load L (FIGS. 1 to 5). The circuit branch component 20 is a component for distributing power from the external power supply B to the plurality of external loads L. The electrical junction box 1 includes a plurality of electronic components 10 and at least one circuit branch component 20.

The electrical junction box 1 includes a block 30 that holds the electronic component 10, and a frame 40 having a cylindrical portion 41 formed of a cylindrical wall 41c of both end openings (opening 41a and 41b) that houses and holds the block 30 in the inside of the cylindrical portion 41 (FIGS. 1 to 7). Then, the electrical junction box 1 includes a cover member (hereinafter, referred to as a “first cover member”) 51 that is fitted to an opening peripheral edge portion (hereinafter, referred to as a “first opening peripheral edge portion”) 41d of a peripheral edge of one opening 41a of the cylindrical portion 41 and closes one opening 41a of the cylindrical portion 41, and a cover member (hereinafter, referred to as a “second cover member”) 52 that is fitted to an opening peripheral edge portion (hereinafter, referred to as a “second opening peripheral edge portion”) 41e of a peripheral edge of the other opening 41b of the cylindrical portion 41 and closes the other opening 41b of the cylindrical portion 41 (FIGS. 1 to 3 and 8). The block 30, the frame 40, the first cover member 51, and the second cover member 52 are formed of an insulating material such as synthetic resin.

In the electrical junction box 1, a housing is configured by the frame 40, the first cover member 51, and the second cover member 52, and an electric wire (not illustrated) electrically connected to the electronic component 10 is drawn in the housing and drawn out from the opening to the outside of the housing.

In the frame 40, the block 30 is inserted into the inside of the cylindrical portion 41 from the other opening 41b. In a case where the frame 40 is configured by one cylindrical portion 41, the entire outer wall forming the outer frame is formed by the cylindrical wall 41c of the cylindrical portion 41. In addition, when the frame 40 is configured by a combination of a plurality of cylindrical portions 41 in which the opening direction of one opening 41a is matched with each other and the opening direction of the other opening 41b is matched with each other, the outer wall forming the outer frame is formed by a combination of some of the cylindrical walls 41c of the plurality of cylindrical portions 41. That is, the outer wall forming the outer frame of the frame 40 is entirely or partially formed by the cylindrical wall 41c of the cylindrical portion 41.

The frame 40 illustrated here is a combination of two cylindrical portions 41, and is mounted on the vehicle with one opening 41a facing the upper side of the vehicle. The first cover member 51 illustrated here is provided for each of the cylindrical portions 41. In addition, the second cover member 52 illustrated here is divided into a first divided cover 52A and a second divided cover 52B assembled with each other, and closes the other opening 41b of each of the two cylindrical portions 41 in a form in which the first divided cover 52A and the second divided cover 52B are assembled (FIGS. 1 to 3, and 8).

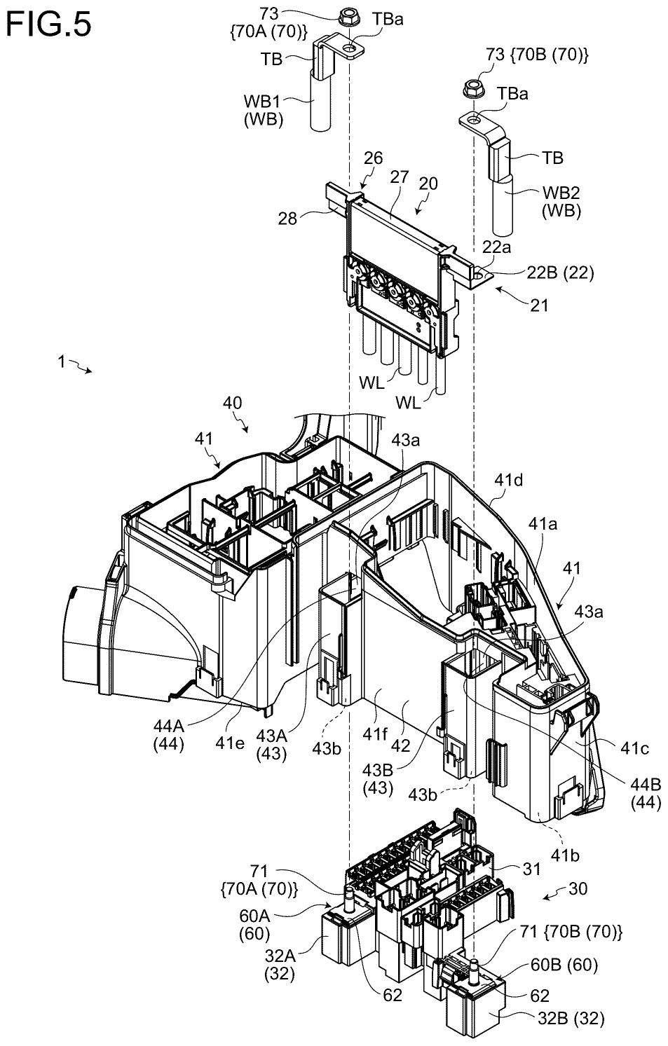

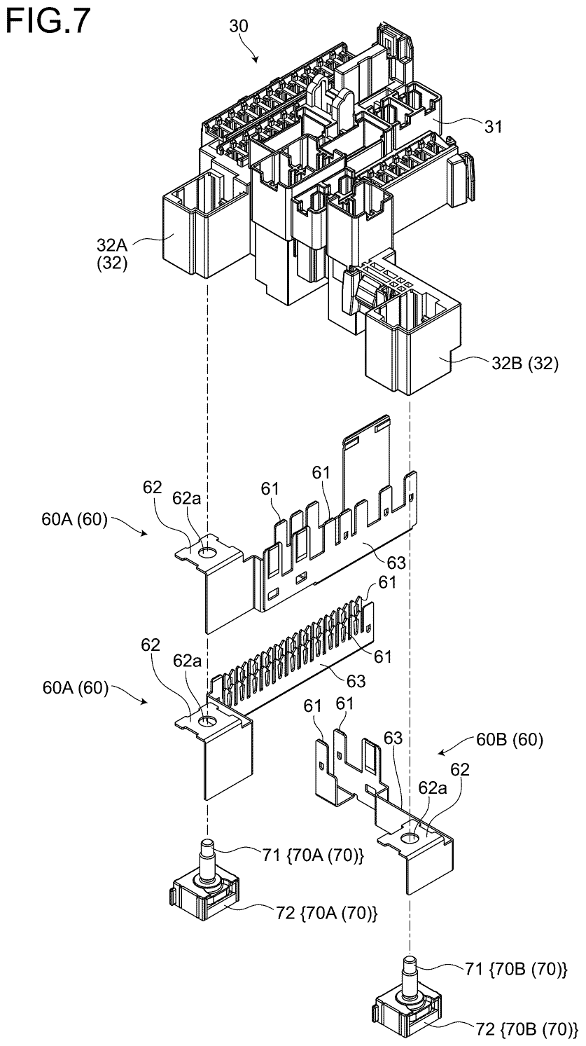

The electrical junction box 1 includes an internal conductive member 60 that electrically connects the electronic component 10 to the external power supply B and is held by the block 30 together with the electronic component 10 (FIGS. 5 to 7). The internal conductive member 60 includes a first electrical connection portion 61 that is physically and electrically connected to the electronic component 10 in the inside of the cylindrical portion 41 (FIG. 7). The first electrical connection portion 61 is provided for each electronic component 10. In addition, the internal conductive member 60 includes a second electrical connection portion 62 electrically connected to the external power supply B (FIGS. 5 and 7). In the internal conductive member 60, the plurality of first electrical connection portions 61 and the second electrical connection portion 62 are connected by a coupling portion 63 (FIG. 7). The internal conductive member 60 illustrated here adopts a shape in which the coupling portion 63 is extended to the outside of the cylindrical portion 41, and the second electrical connection portion 62 is coupled to the coupling portion 63 outside the extended frame 40. That is, the second electrical connection portion 62 is disposed outside the frame 40 and outside the cylindrical portion 41.

The internal conductive member 60 is a so-called bus bar, and is formed in a plate shape using a metal plate as a base material, for example. The block 30 includes a block body 31 that holds the electronic component 10 and the internal conductive member 60 in the inside of the cylindrical portion 41 (FIGS. 1 to 3, and 5, 7, and 8).

Note that the electrical junction box 1 may include the frame 40 integrated with the block 30. The frame 40 includes a cylindrical wall 41c having an opening 41a at least at one end, and has a cylindrical portion 41 that accommodates and holds the electronic component 10 and the internal conductive member 60 in the inside of the cylindrical portion 41. For example, the electrical junction box 1 includes the first cover member 51 and the second cover member 52 as in the above example if the frame 40 has the cylindrical portion 41 including the cylindrical wall 41c having both end openings (opening 41a and 41b). On the other hand, the electrical junction box 1 includes only the first cover member 51 if the frame 40 has the cylindrical portion 41 including the cylindrical wall 41c having the opening 41a only (that is, the cylindrical portion 41 in which the opening 41b is closed).

The circuit branch component 20 is disposed outside the frame 40 and outside the cylindrical portion 41. The circuit branch component 20 includes a conductive circuit branch member 21 interposed between the external power supply B and the external load L (FIGS. 5, 9, and 10).

Here, the circuit branch component 20 includes at least a power supply connection portion 22 and a load connection portion 23 to be described later. Further, the circuit branch component 20 includes a coupling portion 25 to be described later that electrically connects the power supply connection portion 22 and the plurality of load connection portions 23. However, the circuit branch component 20 illustrated here includes, in addition to the power supply connection portion 22 and the load connection portion 23, a fusible portion 24 to be described later for cutting off an overcurrent between the external power supply B and the external load L, and accordingly, includes a coupling portion 25 to be described later. That is, here, as an example of the circuit branch component 20, a circuit protection component for cutting off an overcurrent between the external power supply B and the external load L is exemplified. Therefore, the circuit branch component (circuit protection component) 20 illustrated here includes a conductive circuit protection member interposed between the external power supply B and the external load L as the circuit branch member 21.

The circuit branch member (circuit protection member) 21 is disposed outside the cylindrical portion 41 and outside the frame 40, and includes a power supply connection portion 22 that physically and electrically connects a power supply-side terminal fitting T at an end of the power supply-side electric wire WB electrically connected to the external power supply B and the second electrical connection portion 62 of the internal conductive member 60 (FIGS. 5, 6, 9, and 10).

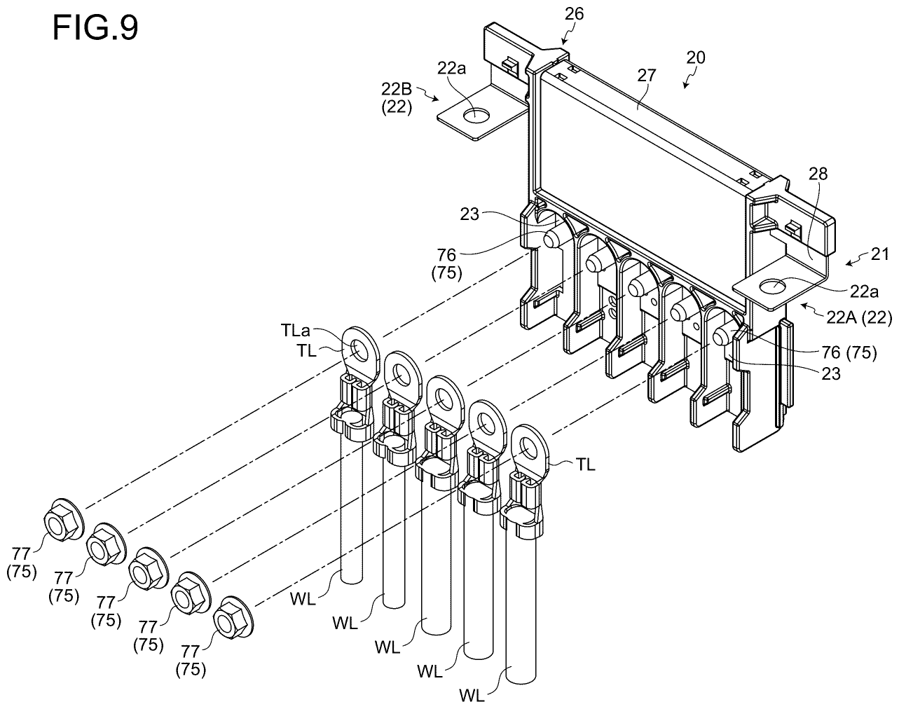

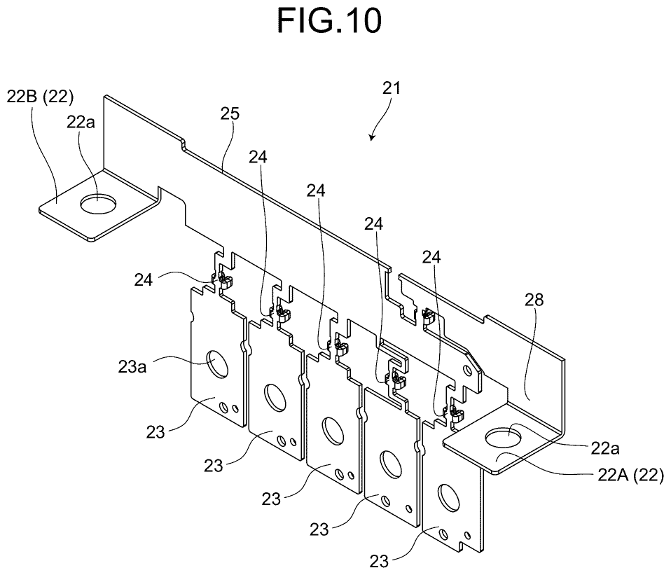

In addition, the circuit branch member (circuit protection member) 21 includes the load connection portion 23 that is disposed outside the cylindrical portion 41 and outside the frame 40 and causes a load-side electric wire WL electrically connected to the external load L to be electrically connected, and the fusible portion 24 that is interposed between the power supply connection portion 22 and the load connection portion 23 and is fused when an overcurrent flows (FIGS. 9 and 10). In the circuit branch member (circuit protection member) 21, the load connection portion 23 and the fusible portion 24 are provided for each external load L. Then, the circuit branch member (circuit protection member) 21 includes the coupling portion 25 that couples the power supply connection portion 22 and the fusible portion 24 (FIG. 10). The power supply connection portion 22 and the fusible portion 24 for each external load L are coupled to the coupling portion 25.

The circuit branch member (circuit protection member) 21 is a so-called bus bar, and is formed in a plate shape using a metal plate as a base material, for example. In the circuit branch component (circuit protection component) 20, a circuit branch member (circuit protection member) 21 embedded in a resin member 26 is interposed between the external power supply B and the external load L. Therefore, in the circuit branch component (circuit protection component) 20, the power supply connection portion 22, the load connection portion 23, and the fusible portion 24 are exposed to the outside of the resin member 26 (FIGS. 9 and 10). Then, in the circuit branch component (circuit protection component) 20, the resin member 26 is integrally molded with the circuit branch member (circuit protection member) 21 using a synthetic resin material in a state where the power supply connection portion 22, the load connection portion 23, and the fusible portion 24 are exposed. Then, in the circuit branch component (circuit protection component) 20, a transparent resin cover 27 made of a synthetic resin material that covers the exposed fusible portion 24 is assembled to the resin member 26 (FIG. 9).

The electrical junction box 1 includes a power supply-side electrical connection structure 70 that physically and electrically connects the power supply-side terminal fitting TB at an end of the power supply-side electric wire WB, the second electrical connection portion 62 of the internal conductive member 60, and the power supply connection portion 22 of the circuit branch member (circuit protection member) 21 to each other (FIGS. 2, 5, and 7). The power supply-side electrical connection structure 70 is disposed outside the frame 40 and outside the cylindrical portion 41. Therefore, the power supply-side electrical connection structure 70 physically and electrically connects the power supply-side terminal fitting TB at an end of the power supply-side electric wire WB, the second electrical connection portion 62 of the internal conductive member 60, and the power supply connection portion 22 of the circuit branch member (circuit protection member) 21 outside the frame 40.

The power supply-side electrical connection structure 70 is a jointly fastening/fixing structure to jointly fasten and fix the power supply-side terminal fitting TB at an end of the power supply-side electric wire WB, the second electrical connection portion 62 of the internal conductive member 60, and the power supply connection portion 22 of the circuit branch member (circuit protection member) 21. The power supply-side electrical connection structure 70 illustrated here includes a male screw member 71, a screw holding member 72 for holding the male screw member 71 in a state where the male screw portion is exposed, and a female screw member 73 to be screwed to the male screw portion of the male screw member 71 (FIGS. 5 to 7). In the power supply-side electrical connection structure 70, the male screw portion of the male screw member 71 is inserted into the through holes TBa, 62a, and 22a provided in the power supply-side terminal fitting TB, the second electrical connection portion 62 of the internal conductive member 60, and the power supply connection portion 22 of the circuit branch member (circuit protection member) 21, respectively, and the female screw member 73 is screwed into the male screw portion, whereby the power supply-side terminal fitting TB, the second electrical connection portion 62 of the internal conductive member 60, and the power supply connection portion 22 of the circuit branch member (circuit protection member) 21 are jointly fastened and fixed (FIGS. 5 to 7).

Here, in the power supply-side electrical connection structure 70, the male screw member 71 is disposed such that the screw axis of the male screw portion is aligned with the vertical direction (that is, the vehicle vertical direction) and the male screw portion protrudes from the screw holding member 72 vertically upward (that is, above the vehicle).

In addition, the electrical junction box 1 includes a load-side electrical connection structure 75 that electrically connects the load-side electric wire WL and the load connection portion 23 of the circuit branch member (circuit protection member) 21 to each other (FIG. 9). A load-side terminal fitting TL is attached to an end of the load-side electric wire WL (FIG. 9). Therefore, the load-side electrical connection structure 75 physically and electrically connects the load-side terminal fitting TL and the load connection portion 23 of the circuit branch member (circuit protection member) 21 to each other.

The load-side electrical connection structure 75 illustrated here includes a male screw member 76 and a female screw member 77 to be screwed to a male screw portion of the male screw member 76 (FIG. 9). A resin member 26 is integrally molded with the male screw member 76 in a state where a male screw portion of the male screw member 76 is inserted into a through hole 23a (FIG. 10) of the load connection portion 23 of the circuit branch member (circuit protection member) 21 and the male screw portion is exposed. In the load-side electrical connection structure 75, a male screw portion of the male screw member 76 is inserted into a through hole TLa provided in the load-side terminal fitting TL, and a female screw member 77 is screwed into the male screw portion, whereby the load-side terminal fitting TL and the load connection portion 23 of the circuit branch member (circuit protection member) 21 are jointly fastened and fixed (FIG. 9).

Here, in the load-side electrical connection structure 75, the male screw member 76 is arranged in a form in which the male screw portion protrudes toward the side of the cylindrical wall 41c of the cylindrical portion 41. In this example, the male screw member 76 is disposed such that a screw axis of the male screw portion is aligned with a direction orthogonal to the vertical direction (that is, the vehicle vertical direction), and the male screw portion protrudes toward a side of the cylindrical wall 41c of the cylindrical portion 41. However, in the load-side electrical connection structure 75, the male screw member 76 may be arranged in a form in which the male screw portion protrudes toward a side opposite to the side of the cylindrical wall 41c of the cylindrical portion 41. In this case, the male screw member 76 is disposed such that a screw axis of the male screw portion is aligned with a direction orthogonal to the vertical direction (that is, the vehicle vertical direction), and the male screw portion protrudes toward a side opposite to the side of the cylindrical wall 41c of the cylindrical portion 41.

Specifically, the circuit branch component (circuit protection component) 20 is disposed outside the frame 40 as follows.

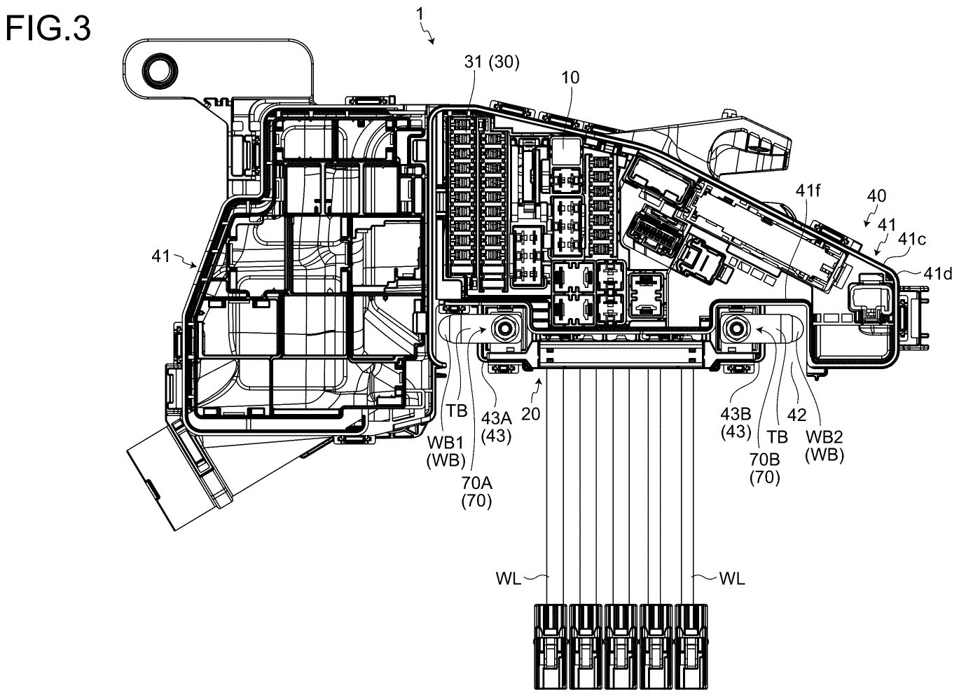

The frame 40 has a recess 42 in which the circuit branch component (circuit protection component) 20 is disposed by recessing an outer wall forming the outer frame toward the inside of the cylindrical portion 41 (FIGS. 3, 4, 5, and 11). The recess 42 desirably has a volume equal to or larger than the size of the circuit branch component (circuit protection component) 20 and can be accommodated without protruding the circuit branch component (circuit protection component) 20. For example, the cylindrical wall 41c of the cylindrical portion 41 has an opposing wall body 41f arranged to face the circuit branch component (circuit protection component) 20 outside the cylinder. The recess 42 is formed by recessing the opposing wall body 41f toward the inside of the cylinder.

In addition, the frame 40 is provided with an opening 43a that opens in the same direction as the one opening 41a of the cylindrical portion 41, and has a sub-cylindrical portion 43 bulging out of the frame 40 outside the cylinder of the cylindrical portion 41 from the cylindrical wall 41c of the cylindrical portion 41 (FIGS. 1 to 5, 8, and 11). The sub-cylindrical portion 43 bulges out of the frame 40 outside the cylindrical portion 41 from the opposing wall body 41f. The sub-cylindrical portion 43 illustrated here is formed as a cylindrical body having both end openings (openings 43a and 43b) bulging from the opposing wall body 41f at the recess 42 of the frame 40. Therefore, in the sub-cylindrical portion 43, the one opening 43a is arranged on the one opening 41a side of the cylindrical portion 41 (that is, a side of the first opening peripheral edge portion 41d), and the other opening 43b is arranged on the other opening 41b side of the cylindrical portion 41 (that is, a side of the second opening peripheral edge portion 41e).

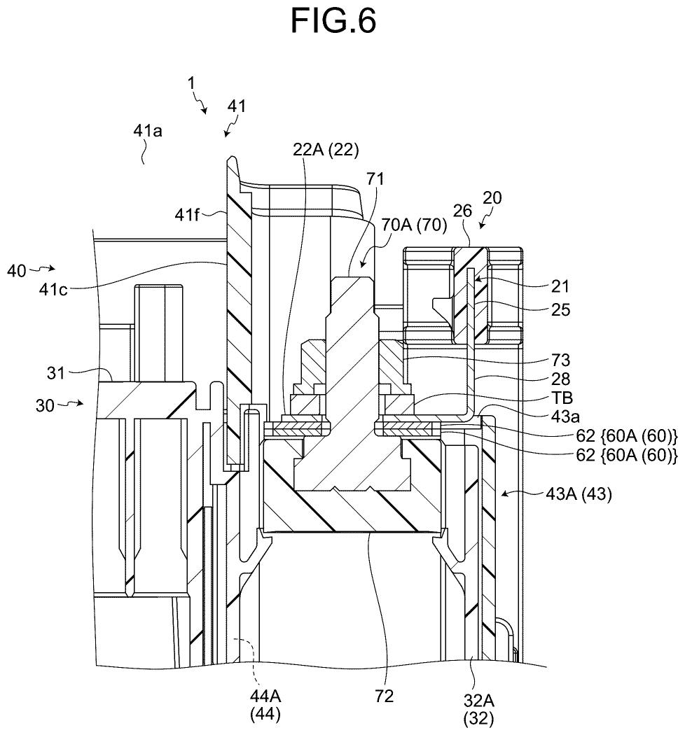

In the inside of the sub-cylindrical portion 43, the power supply-side electrical connection structure 70 is provided in a form in which a male screw portion of the male screw member 71 protrudes from one opening 43a. In the sub-cylindrical portion 43, the screw holding member 72 of the power supply-side electrical connection structure 70 is accommodated in the inside of the cylinder, and the male screw portion of the male screw member 71 and the female screw member 73 in the power supply-side electrical connection structure 70 protrude from the one opening 43a. Therefore, in the second electrical connection portion 62 of the internal conductive member 60, the male screw portion of the male screw member 71 protruding from the one opening 43a of the sub-cylindrical portion 43 is inserted into the through hole 62a. Therefore, the cylindrical wall 41c of the cylindrical portion 41 has a notch 44 that allows the inside of its own cylinder to communicate with the inside of the sub-cylindrical portion 43 and causes the second electrical connection portion 62 of the internal conductive member 60 to protrude to the outside of the frame 40 outside the cylindrical portion 41 (FIGS. 5 and 6). The notch 44 is a notch obtained by cutting out the cylindrical wall 41c of the cylindrical portion 41 from the second opening peripheral edge portion 41e toward the first opening peripheral edge portion 41d. Here, the notch 44 is formed in the opposing wall body 41f.

The block 30 has a protruding block portion 32 that protrudes from the notch 44 to the outside of the cylindrical portion 41 and is accommodated in the inside of the sub-cylindrical portion 43 (FIGS. 5 to 7). The screw holding member 72 is assembled to the protruding block portion 32, whereby the power supply-side electrical connection structure 70 is held.

In the electrical junction box 1, in a state where the internal conductive member 60 is held by the block body 31 and the power supply-side electrical connection structure 70 is held by the protruding block portion 32, the male screw portion of the male screw member 71 of the power supply-side electrical connection structure 70 is inserted into the through hole 62a of the second electrical connection portion 62 of the internal conductive member 60. In the electrical junction box 1, the block body 31 holding the internal conductive member 60 is inserted into the inside of the cylindrical portion 41 from the other opening 41b, and the protruding block portion 32 holding the power supply-side electrical connection structure 70 is inserted into the inside of the sub-cylindrical portion 43 from the other opening 43b together with the second electrical connection portion 62 of the internal conductive member 60.

In the electrical junction box 1, the male screw portion of the male screw member 71 is inserted into the through hole 22a to assemble the power supply connection portion 22 of the circuit branch member (circuit protection member) 21 to the power supply-side electrical connection structure 70, and further, the male screw portion of the male screw member 71 is inserted into the through hole TBa to assemble the power supply-side terminal fitting TB to the power supply-side electrical connection structure 70. In the electrical junction box 1, the female screw member 73 is screwed into the male screw portion of the male screw member 71 to jointly fasten and fix the power supply-side terminal fitting TB, the second electrical connection portion 62 of the internal conductive member 60, and the power supply connection portion 22 of the circuit branch member (circuit protection member) 21. In the electrical junction box 1, the power supply-side terminal fitting TB and the circuit branch component (circuit protection component) 20 are assembled to the block 30 via the power supply-side electrical connection structure 70.

The one opening 43a of the sub-cylindrical portion 43 is covered with the first cover member 51 assembled to the frame 40 together with the power supply-side terminal fitting TB, the second electrical connection portion 62 of the internal conductive member 60, the power supply connection portion 22 of the circuit branch member (circuit protection member) 21, and the power supply-side electrical connection structure 70, and is accommodated in the first cover member 51. Further, the first cover member 51 covers the recess 42 of the frame 40, and houses the circuit branch component (circuit protection component) 20 in the recess 42 in the space between the recess 42 and the first cover member 51.

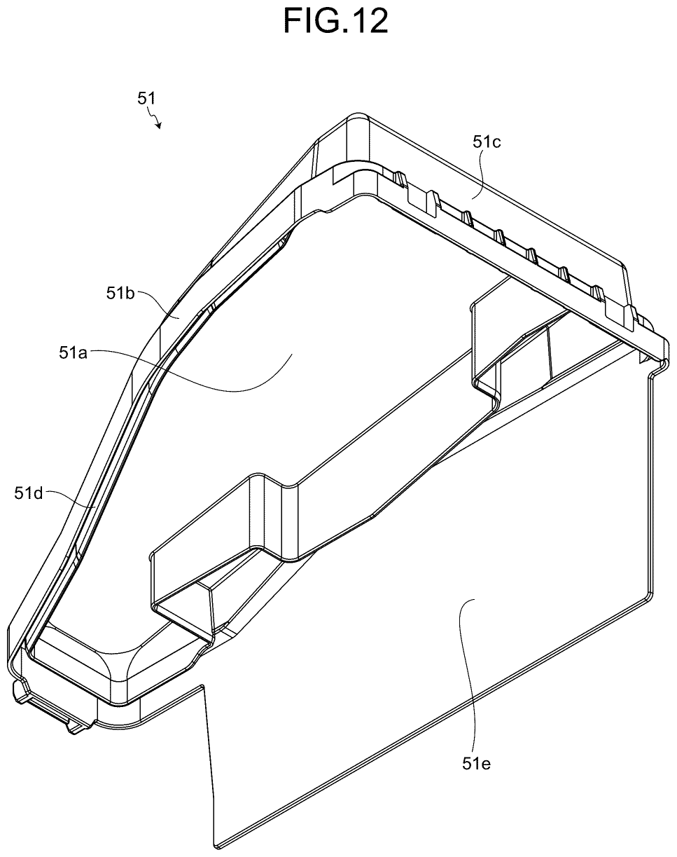

Specifically, the first cover member 51 includes a cover main body 51a that is arranged to face one opening 41a of the cylindrical portion 41, an annular outer peripheral wall body 51b that covers the first opening peripheral edge portion 41d from the outside of the cylindrical portion 41, a closing wall body 51c that closes a gap between the cover main body 51a and the outer peripheral wall body 51b, an annular inner peripheral wall body 51d that is arranged with a space from the outer peripheral wall body 51b inside the outer peripheral wall body 51b and is fitted to the first opening peripheral edge portion 41d, and a waterproof cover wall body 51e that protrudes from the outer peripheral wall body 51b to a position to cover the power supply-side electrical connection structure 70 with the cylindrical wall 41c of the cylindrical portion 41 (FIG. 12).

The other opening 43b of the sub-cylindrical portion 43 is closed by a closing portion 53 provided in the second cover member 52 assembled to the frame 40 so as not to be exposed to the outside of the frame 40 (FIGS. 1, 4, 8, and 13).

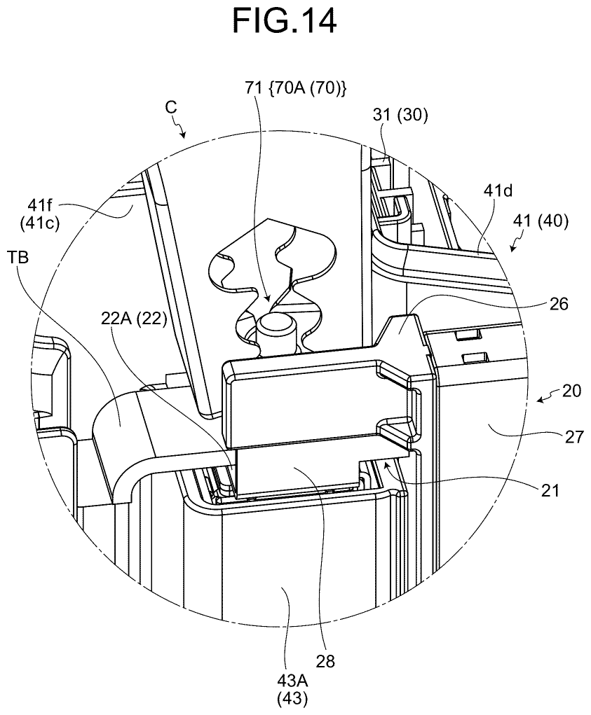

Meanwhile, in the electrical junction box 1, a power feeding structure for feeding power from a rescue vehicle or the like to a secondary battery (external power supply B) having a reduced voltage is provided outside the frame 40. Here, the power supply-side electrical connection structure 70 is provided with conductivity, and the power supply-side electrical connection structure 70 is used for the power feeding structure. Therefore, the power supply-side electrical connection structure 70 is configured to be able to allow the clip C at an end of the booster cable to be engaged (FIGS. 2 and 14).

Therefore, first, in the power supply-side electrical connection structure 70, the male screw member 71 and the female screw member 73 formed of a conductive material such as metal are used, and the female screw member 73 is held by the clip C (FIGS. 2 and 14). The clip C holds the female screw member 73 from the side surface. An attaching/detaching work space for attaching/detaching the clip C to/from the power supply-side electrical connection structure 70 is provided between the frame 40 and the power supply-side electrical connection structure 70. For example, in order to provide the attaching/detaching work space, the frame 40 is formed in a shape that can secure the attaching/detaching work space between the frame 40 and the power supply-side electrical connection structure 70. Further, the power supply-side electrical connection structure 70 is disposed at a position where the attaching/detaching work space can be secured between the frame 40 and the power supply-side electrical connection structure 70 in order to provide the attaching/detaching work space.

Here, the circuit branch component (circuit protection component) 20 may be provided with a non-contact portion 28 which is disposed with a space from the side surface of the female screw member 73 in a state where the power supply connection portion 22 is jointly fastened and fixed and can be held by the clip C together with the female screw member 73 (FIGS. 5, 6, 9, 10, and 15). The non-contact portion 28 protrudes from the resin member 26 and is coupled to the power supply connection portion 22. The non-contact portion 28 is provided in the circuit branch member (circuit protection member) 21. Here, the non-contact portion 28 is bent by 90 degrees vertically upward (vehicle upper side) with respect to the power supply connection portion 22, whereby the inner wall surface of the cylindrical portion 41 of the non-contact portion 28 on the cylindrical wall 41c side (the opposing wall body 41f side) is arranged to face the side surface of the female screw member 73 with a space therebetween. The clip C sandwiches the female screw member 73 and the non-contact portion 28 together from the side surface of the female screw member 73 and the outer wall surface of the non-contact portion 28.

In the electrical junction box 1, all the core wires of the power supply-side electric wire WB and the load-side electric wire WL may be formed of copper or a copper alloy. However, in order to reduce the weight of the power supply-side electric wire WB and the load-side electric wire WL, at least one core wire thereof is desirably formed of aluminum or an aluminum alloy. For example, all the core wires of the power supply-side electric wire WB and the load-side electric wire WL may be formed of aluminum or an aluminum alloy, or at least one core wire may be formed of aluminum or an aluminum alloy, and the remaining core wires may be formed of copper or a copper alloy.

When the core wire of the power supply-side electric wire WB and the load-side electric wire WL is molded using aluminum or an aluminum alloy, the weight of the power supply-side electric wire WB and the load-side electric wire WL can be reduced as compared with a case where the core wire is molded using copper or a copper alloy. However, the power supply-side electric wire WB and the load-side electric wire WL are thick and hard in response to a large current, and are difficult to bend. However, in the electrical junction box 1, the circuit branch component (circuit protection component) 20 is disposed outside the frame 40 and outside the cylinder of the cylindrical portion 41, and the power supply-side electric wire WB and the load-side electric wire WL, which are difficult to bend, are routed outside the frame 40. Therefore, the electrical junction box 1 can suppress an overload on the periphery in the housing due to the power supply-side electric wire WB or the like, and can improve the housing property of other electric wires in the inside of the cylindrical portion 41.

Specifically, the electrical junction box 1 illustrated here includes a first internal conductive member 60A and a second internal conductive member 60B as the internal conductive member 60, and the first internal conductive member 60A and the second internal conductive member 60B are held by the block 30 (FIGS. 5 and 7). Here, two types of first internal conductive members 60A are provided as the internal conductive members 60.

Further, the circuit branch member (circuit protection member) 21 illustrated here includes a first power supply connection portion 22A and a second power supply connection portion 22B as the power supply connection portion 22, and the first power supply connection portion 22A and the second power supply connection portion 22B are electrically connected to a first power supply-side electric wire WB1 and a second power supply-side electric wire WB2 as the power supply-side electric wires WB, respectively (FIGS. 5, 9, and 10). In the circuit branch member (circuit protection member) 21, the first power supply connection portion 22A and the second power supply connection portion 22B are coupled by the coupling portion 25, and the fusible portion 24 is coupled to the first power supply connection portion 22A and the second power supply connection portion 22B via the coupling portion 25. That is, the fusible portion 24 is interposed between the first power supply connection portion 22A and the load connection portion 23, and is interposed between the second power supply connection portion 22B and the load connection portion 23.

The first power supply-side electric wire WB1 is interposed between the first power supply connection portion 22A and the external power supply B when viewed from the circuit branch member (circuit protection member) 21, and electrically connects the first power supply connection portion 22A to the external power supply B. The second power supply-side electric wire WB2 is electrically connected to an external electric component P such as an alternator or a DC-DC converter disposed outside the housing, and is electrically connected to the external power supply B via the circuit branch member (circuit protection member) 21 and the first power supply-side electric wire WB1. That is, the second power supply-side electric wire WB2 electrically connects the external electric component P to the external power supply B via the circuit branch member (circuit protection member) 21 and the first power supply-side electric wire WB1.

The first power supply connection portion 22A physically and electrically connects the power supply-side terminal fitting TB at an end of the first power supply-side electric wire WB1 and a second electrical connection portion 62 of a first internal conductive member 60A. The electrical junction box 1 includes, as the power supply-side electrical connection structure 70, a first power supply-side electrical connection structure 70A that physically and electrically connects the power supply-side terminal fitting TB at an end of the first power supply-side electric wire WB1, the second electrical connection portion 62 of the first internal conductive member 60A, and the first power supply connection portion 22A of the circuit branch member (circuit protection member) 21 to each other (FIGS. 3, and 5 to 7). In the first power supply-side electrical connection structure 70A, the male screw portion of the male screw member 71 is inserted into the through holes TBa, 62a, and 22a provided in the power supply-side terminal fitting TB at an end of the first power supply-side electric wire WB1, the second electrical connection portion 62 of the first internal conductive member 60A, and the first power supply connection portion 22A of the circuit branch member (circuit protection member) 21, respectively, and the female screw member 73 is screwed into the male screw portion, whereby the power supply-side terminal fitting TB, the second electrical connection portion 62 of the first internal conductive member 60A, and the first power supply connection portion 22A of the circuit branch member (circuit protection member) 21 are jointly fastened and fixed. Here, the power supply-side terminal fitting TB, the second electrical connection portion 62 of each of the two first internal conductive members 60A, and the first power supply connection portion 22A of the circuit branch member (circuit protection member) 21 are jointly fastened and fixed.

The frame 40 illustrated here includes, as the sub-cylindrical portion 43, a first sub-cylindrical portion 43A provided with an opening (one opening 43a) that opens in the same direction as the one opening 41a of the cylindrical portion 41 (FIGS. 1 to 6, 8, and 11). In the first sub-cylindrical portion 43A, the first power supply-side electrical connection structure 70A is accommodated in the inside of the cylinder, and the male screw portion of the male screw member 71 and the female screw member 73 in the first power supply-side electrical connection structure 70A protrudes from the one opening 43a. The first sub-cylindrical portion 43A is provided in the recess 42 of the frame 40. In the cylindrical wall 41c of the cylindrical portion 41, as the notch 44, there is provided a first notch 44A that allows the inside of its own cylinder to communicate with the inside of the cylinder of the first sub-cylindrical portion 43A and causes the second electrical connection portion 62 of the first internal conductive member 60A to protrude to the outside of the frame 40 outside the cylinder of the cylindrical portion 41 (FIGS. 5 and 6). Then, as the protruding block portion 32 to which the screw holding member 72 of the first power supply-side electrical connection structure 70A is assembled, the block 30 is provided with a first protruding block portion 32A that protrudes from the first notch 44A to the outside of the cylindrical portion 41 and is accommodated in the inside of the first sub-cylindrical portion 43A (FIGS. 5 to 7).

In the electrical junction box 1, the first protruding block portion 32A, the first power supply-side electrical connection structure 70A, and the second electrical connection portion 62 of the two first internal conductive members 60A are accommodated in the inside of the first sub-cylindrical portion 43A in a state where the male screw portion of the male screw member 71 is taken out from the one opening 43a of the first sub-cylindrical portion 43A (FIG. 6).

Here, in the electrical junction box 1, the first power supply-side electrical connection structure 70A is used as a power feeding structure (FIGS. 2 and 14). Therefore, in the electrical junction box 1, the female screw member 73 of the first power supply-side electrical connection structure 70A can be held by the clip C from the side surface (FIGS. 2 and 14), or the female screw member 73 and the non-contact portion 28 connected to the first power supply connection portion 22A can be held together from the side surface of the female screw member 73 and the outer wall surface of the non-contact portion 28 (FIGS. 5, 6, 9, 10, and 15).

The second power supply connection portion 22B physically and electrically connects the power supply-side terminal fitting TB at an end of the second power supply-side electric wire WB2 and the second electrical connection portion 62 of the second internal conductive member 60B. The electrical junction box 1 includes, as the power supply-side electrical connection structure 70, a second power supply-side electrical connection structure 70B that physically and electrically connects the power supply-side terminal fitting TB at an end of the second power supply-side electric wire WB2, the second electrical connection portion 62 of the second internal conductive member 60B, and the second power supply connection portion 22B of the circuit branch member (circuit protection member) 21 to each other (FIGS. 3, 5, and 7). In the second power supply-side electrical connection structure 70B, the male screw portion of the male screw member 71 is inserted into the through holes TBa, 62a, and 22a provided in the power supply-side terminal fitting TB at an end of the second power supply-side electric wire WB2, the second electrical connection portion 62 of the second internal conductive member 60B, and the second power supply connection portion 22B of the circuit branch member (circuit protection member) 21, respectively, and the female screw member 73 is screwed into the male screw portion, whereby the power supply-side terminal fitting TB, the second electrical connection portion 62 of the second internal conductive member 60B, and the second power supply connection portion 22B of the circuit branch member (circuit protection member) 21 are jointly fastened and fixed.

The frame 40 illustrated here includes, as the sub-cylindrical portion 43, a second sub-cylindrical portion 43B provided with an opening (one opening 43a) that opens in the same direction as the one opening 41a of the cylindrical portion 41 (FIGS. 1 to 5, 8, and 11). In the second sub-cylindrical portion 43B, the second power supply-side electrical connection structure 70B is accommodated in the cylinder, and the male screw portion of the male screw member 71 in the second power supply-side electrical connection structure 70B protrudes from the one opening 43a. The second sub-cylindrical portion 43B is provided in the recess 42 of the frame 40. In the cylindrical wall 41c of the cylindrical portion 41, as the notch 44, there is provided a second notch 44B that allows the inside of its own cylinder to communicate with the inside of the cylinder of the second sub-cylindrical portion 43B and causes the second electrical connection portion 62 of the second internal conductive member 60B to protrude to the outside of the frame 40 outside the cylindrical portion 41 (FIG. 5). Then, as the protruding block portion 32 to which the screw holding member 72 of the second power supply-side electrical connection structure 70B is assembled, the block 30 is provided with a second protruding block portion 32B that protrudes from the second notch 44B to the outside of the cylindrical portion 41 and is accommodated in the inside of the second sub-cylindrical portion 43B (FIGS. 5 and 7).

In the electrical junction box 1, the second protruding block portion 32B, the second power supply-side electrical connection structure 70B, and the second electrical connection portion 62 of the second internal conductive members 60B are accommodated in the inside of the second sub-cylindrical portion 43B in a state where the male screw portion of the male screw member 71 is taken out from the one opening 43a of the second sub-cylindrical portion 43B.

In the electrical junction box 1, the male screw portion of the male screw member 71 of the first power supply-side electrical connection structure 70A is inserted into the through hole 22a of the first power supply connection portion 22A to assemble the first power supply connection portion 22A to the first power supply-side electrical connection structure 70A, and the male screw portion of the male screw member 71 of the second power supply-side electrical connection structure 70B is inserted into the through hole 22a of the second power supply connection portion 22B to assemble the second power supply connection portion 22B to the second power supply-side electrical connection structure 70B. Then, in the electrical junction box 1, the male screw portion of the male screw member 71 of the first power supply-side electrical connection structure 70A is inserted into the through hole TBa of the power supply-side terminal fitting TB of the first power supply-side electric wire WB1, and the power supply-side terminal fitting TB is assembled to the first power supply-side electrical connection structure 70A, and the male screw portion of the male screw member 71 of the second power supply-side electrical connection structure 70B is inserted into the through hole TBa of the power supply-side terminal fitting TB of the second power supply-side electric wire WB2, and the power supply-side terminal fitting TB is assembled to the second power supply-side electrical connection structure 70B. In the electrical junction box 1, the female screw members 73 are screwed into the male screw portions of the respective male screw members 71 to jointly fasten and fix the power supply-side terminal fitting TB of the first power supply-side electric wire WB1, the respective second electrical connection portions 62 of the two first internal conductive members 60A, and the first power supply connection portion 22A of the circuit branch member (circuit protection member) 21, and jointly fasten and fix the power supply-side terminal fitting TB of the second power supply-side electric wire WB2, the second electrical connection portion 62 of the second internal conductive member 60B, and the second power supply connection portion 22B of the circuit branch member (circuit protection member) 21. In the electrical junction box 1, the two power supply-side terminal fittings TB and the circuit branch component (circuit protection component) 20 are assembled to the block 30 via the first power supply-side electrical connection structure 70A and the second power supply-side electrical connection structure 70B.

One opening 43a of each of the first sub-cylindrical portion 43A and the second sub-cylindrical portion 43B is covered with the first cover member 51 together with the two power supply-side terminal fittings TB, the second electrical connection portions 62 of each of the two first internal conductive members 60A and the second internal conductive member 60B, the first power supply connection portion 22A and the second power supply connection portion 22B of the circuit branch member (circuit protection member) 21, the first power supply-side electrical connection structure 70A and the second power supply-side electrical connection structure 70B, and is housed in the first cover member 51. Therefore, in the electrical junction box 1, the first cover member 51 is removed when the clip C is engaged in the first power supply-side electrical connection structure 70A.

The second cover member 52 includes, as the closing portion 53, a first closing portion 53A that closes the other opening 43b of the first sub-cylindrical portion 43A so as not to be exposed to the outside of the frame 40, and a second closing portion 53B that closes the other opening 43b of the second sub-cylindrical portion 43B so as not to be exposed to the outside of the frame 40 (FIGS. 1, 2, 4, 8, and 13). The first closing portion 53A and the second closing portion 53B may be one plate-shaped wall portion that closes the other opening 43b from the outside of the frame 40 together with the first notch 44A and the second notch 44B, or may be formed of a plurality of wall portions that surrounds and covers the other opening 43b from the outside of the frame 40 together with the first notch 44A and the second notch 44B. Here, the first divided cover 52A is assembled to the peripheral edge of the other opening 41b of the cylindrical portion 41 provided with the first sub-cylindrical portion 43A and the second sub-cylindrical portion 43B. Therefore, the first closing portion 53A and the second closing portion 53B are provided in the first divided cover 52A.

As described above, in the electrical junction box 1 of the present embodiment, since the circuit branch component (circuit protection component) 20 is disposed outside the cylindrical portion 41 and outside the frame 40, it is possible to suppress the peripheral overload in the housing by the power supply-side electric wire WB (first power supply-side electric wire WB1 and second power supply-side electric wire WB2) and the load-side electric wire WL connected to the circuit branch component (circuit protection component) 20. In particular, in the electrical junction box 1, since the power supply-side electric wire WB (first power supply-side electric wire WB1 and second power supply-side electric wire WB2) and the load-side electric wire WL are less likely to bend as the electric wire diameter increases, it is possible to suppress an overload of the power supply-side electric wire WB and the like to the periphery in the housing. For example, in the electrical junction box 1, the deformation of the second cover member 52 can be suppressed by suppressing the overload on the second cover member 52 in the housing due to the power supply-side electric wire WB or the like. In addition, the electrical junction box 1 can improve the housing property of other electric wires in the inside of the cylindrical portion 41 by routing the power supply-side electric wire WB or the like that is difficult to bend outside the frame 40. In addition, in the electrical junction box 1, by routing the power supply-side electric wire WB and the like outside the frame 40, the heat generated by the power supply-side electric wire WB and the like does not stagnate in the housing, so that a temperature rise in the housing can be suppressed. Further, in the electrical junction box 1, while these effects are exhibited, the power supply-side electrical connection structure 70 (the first power supply-side electrical connection structure 70A) outside the frame 40 related to the circuit branch component (circuit protection component) 20 is used as a power feeding structure so that a degree of freedom can be given to a component layout in the housing.

In the electrical junction box according to the present embodiment, the circuit branch component is disposed outside the frame and outside the cylindrical portion, and the power supply-side electrical connection structure outside the frame related to the circuit branch component is used as the power feeding structure, so that the component layout in the housing can have a degree of freedom.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electrical junction box comprising:
an electronic component;
an internal conductive member that electrically connects the electronic component to an external power supply;
a frame including a cylindrical wall provided with an opening at least at one end, and having a cylindrical portion that houses and holds the electronic component and the internal conductive member in the inside of the cylindrical portion;
a cover member that is fitted to an opening peripheral edge portion of a peripheral edge of the opening of the cylindrical portion and closes the opening of the cylindrical portion; and
a circuit branch component that is disposed outside the frame and outside the cylindrical portion and is interposed between the external power supply and an external load, wherein
the internal conductive member includes a first electrical connection portion and a second electrical connection portion that are physically and electrically connected to the electronic component in the inside of the cylindrical portion,
the circuit branch component is disposed outside the frame and outside the cylindrical portion and includes a power supply connection portion that physically and electrically connects a power supply-side terminal fitting at an end of a power supply-side electric wire electrically connected to the external power supply and the second electrical connection portion of the internal conductive member, and a load connection portion that causes a load-side electric wire electrically connected to the external load to be electrically connected,
a conductive power supply-side electrical connection structure that physically and electrically connects the power supply-side terminal fitting at an end of the power supply-side electric wire, the second electrical connection portion of the internal conductive member, and the power supply connection portion of the circuit branch component, and is capable of causing a clip at an end of the booster cable to be engaged is provided outside the cylindrical portion and outside the frame, and
an attaching/detaching work space for attaching and detaching the clip to and from the power supply-side electrical connection structure is provided between the frame and the power supply-side electrical connection structure.

2. The electrical junction box according to claim 1, wherein
the power supply-side electrical connection structure is a jointly fastening/fixing structure for jointly fastening and fixing the power supply-side terminal fitting at an end of the power supply-side electric wire, the second electrical connection portion of the internal conductive member, and the power supply connection portion of the circuit branch component, and includes a male screw member that inserts a male screw portion into each of through holes of the power supply-side terminal fitting, the second electrical connection portion, and the power supply connection portion, and a female screw member capable of being held by the clip and screwed to the male screw portion of the male screw member.

3. The electrical junction box according to claim 1, wherein
the power supply-side electrical connection structure is a jointly fastening/fixing structure for jointly fastening and fixing the power supply-side terminal fitting at an end of the power supply-side electric wire, the second electrical connection portion of the internal conductive member, and the power supply connection portion of the circuit branch component, and includes a male screw member that inserts a male screw portion into each of through holes of the power supply-side terminal fitting, the second electrical connection portion, and the power supply connection portion, and a female screw member to be screwed to the male screw portion of the male screw member, and
the circuit branch component is provided with a non-contact portion that is disposed with a space from a side surface of the female screw member in a state where the power supply connection portion is jointly fastened and fixed and that can be held by the clip together with the female screw member.

4. The electrical junction box according to claim 2, wherein
the frame is provided with an opening that opens in the same direction as the opening of the cylindrical portion, and includes a sub cylindrical portion bulging out of the frame from the cylindrical wall of the cylindrical portion outside the cylindrical portion,
the cylindrical wall of the cylindrical portion has a notch that allows the inside of the cylindrical portion to communicate with the inside of the sub-cylindrical portion and causes the second electrical connection portion of the internal conductive member to protrude to the outside of the frame outside the cylindrical portion, and
the power supply-side electrical connection structure is provided in the inside of the sub-cylindrical portion such that the male screw portion of the male screw member and the female screw member protrude from the opening of the sub-cylindrical portion.

5. The electrical junction box according to claim 3, wherein
the frame is provided with an opening that opens in the same direction as the opening of the cylindrical portion, and includes a sub cylindrical portion bulging out of the frame from the cylindrical wall of the cylindrical portion outside the cylindrical portion,
the cylindrical wall of the cylindrical portion has a notch that allows the inside of the cylindrical portion to communicate with the inside of the sub-cylindrical portion and causes the second electrical connection portion of the internal conductive member to protrude to the outside of the frame outside the cylindrical portion, and
the power supply-side electrical connection structure is provided in the inside of the sub-cylindrical portion such that the male screw portion of the male screw member and the female screw member protrude from the opening of the sub-cylindrical portion.

6. The electrical junction box according to claim 1, wherein
the cover member includes a cover main body that is disposed to face the opening of the cylindrical portion, an annular outer peripheral wall body that covers the opening peripheral edge portion from the outside of the cylindrical portion, a closing wall body that closes a gap between the cover main body and the outer peripheral wall body, an annular inner peripheral wall body that is disposed inside the outer peripheral wall body with a space from the outer peripheral wall body and is fitted to the opening peripheral edge portion, and a waterproof cover wall body that protrudes from the outer peripheral wall body to a position where the power supply-side electrical connection structure is covered between the cylindrical wall of the cylindrical portion and the power supply-side electric connection structure.

7. The electrical junction box according to claim 2, wherein
the cover member includes a cover main body that is disposed to face the opening of the cylindrical portion, an annular outer peripheral wall body that covers the opening peripheral edge portion from the outside of the cylindrical portion, a closing wall body that closes a gap between the cover main body and the outer peripheral wall body, an annular inner peripheral wall body that is disposed inside the outer peripheral wall body with a space from the outer peripheral wall body and is fitted to the opening peripheral edge portion, and a waterproof cover wall body that protrudes from the outer peripheral wall body to a position where the power supply-side electrical connection structure is covered between the cylindrical wall of the cylindrical portion and the power supply-side electric connection structure.

8. The electrical junction box according to claim 3, wherein
the cover member includes a cover main body that is disposed to face the opening of the cylindrical portion, an annular outer peripheral wall body that covers the opening peripheral edge portion from the outside of the cylindrical portion, a closing wall body that closes a gap between the cover main body and the outer peripheral wall body, an annular inner peripheral wall body that is disposed inside the outer peripheral wall body with a space from the outer peripheral wall body and is fitted to the opening peripheral edge portion, and a waterproof cover wall body that protrudes from the outer peripheral wall body to a position where the power supply-side electrical connection structure is covered between the cylindrical wall of the cylindrical portion and the power supply-side electric connection structure.
